(19) United States
(12) Patent Application Publication
(10) Pub. No.: US 2021/0053017 A1
(43) Pub. Date: Feb. 25, 2021

(54) MICROPARTICLE-CONTAINING LIQUID DISPERSING DEVICE, MICROPARTICLE SEDIMENTATION SUPPRESSION METHOD, MICROPARTICLE SORTING OR MEASURING DEVICE, AND MICROPARTICLE SEDIMENTATION SUPPRESSION VIBRATOR

(71) Applicant: SONY CORPORATION, TOKYO (JP)

(72) Inventor: Naohisa SAKAMOTO, TOKYO (JP)

(21) Appl. No.: 16/982,264

(22) PCT Filed: Jan. 9, 2019
(86) PCT No.: PCT/JP2019/000310

§ 371 Date: Sep. 18, 2020

(30) Foreign Application Priority Data
Mar. 27, 2018 (JP) 2018-060330

(51) Int. Cl. B01F 11/02; B01F 3/12; G01N 15/14

(52) U.S. Cl. CPC B01F 11/0266; G01N 15/14; B01F 3/1207

(57) ABSTRACT

To provide a microparticle-containing liquid dispersing device capable of dispersing microparticles containing cells, a microparticle sedimentation suppression method, a microparticle sorting or measuring device, and a microparticle sedimentation suppression vibrator. The microparticle-containing liquid dispersing device includes: a microparticle sedimentation suppression vibrator including a fixture configured to connect and hang on a bag containing a microparticle-containing liquid, the microparticle sedimentation suppression vibrator hanging the bag in a vertically downward direction; and a stand that hangs the bag.

### TECHNICAL FIELD

The present invention relates to a microparticle-containing liquid dispersing device, a microparticle sedimentation suppression method, a microparticle sorting or measuring device, and a microparticle sedimentation suppression vibrator.

### BACKGROUND ART

In recent years, research on regenerative medicine and cell therapy has been actively pursued, and there is an increasing need for a flow cytometer as a method for quickly evaluating cells. The flow cytometer is an analytical method for performing analysis and sorting of cells by pouring cells to be analyzed in a state of being aligned into a fluid, and irradiating the cells with laser light or the like to detect fluorescence or scattered light emitted from each cell. The flow cytometer is used as a tool for analyzing cells in research on regenerative medicine and cell therapy. Then, various cell analysis devices have been developed (Patent Documents 1 to 4).

A problem has been known that when a cell-containing liquid is poured into the cell analysis device, if the liquid is fed without stirring, the tube is likely to be clogged due to the high-concentration liquid feeding, and the stability of the cell-containing liquid supply destination device is impaired. Then, in particular, in feeding to the cell analysis device, a problem has been known that a high-concentration cell-containing liquid flows, so that the sorting process cannot be performed in time and the cell-containing liquid is wasted.

### CITATION LIST

### Patent Document

### Patent Document 1: Japanese Patent Application Laid-Open No. 2012-127922

### Patent Document 2: Japanese Patent Application Laid-Open No. 2013-210287

### Patent Document 3: Japanese Patent Application Laid-Open No. 2014-036604

### Patent Document 4: Japanese Patent Application Laid-Open No. 2014-202573

### SUMMARY OF THE INVENTION

### Problems to be Solved by the Invention

Since the cell-containing liquid has a higher specific gravity of cells than water, the cell-containing liquid sediments when left standing. Flow cytometry is capable of selectively sorting target cells from a multi-cell suspension, but the sorting success rate depends on the concentration of the cell-containing liquid. In particular, in a case where the cell concentration is high, the cells are caused to flow in close proximity, which greatly affects the abort rate and the purity, and it is desired that the liquid is fed at a constant concentration during sorting.

In the case of a general flow cytometer, the cell-containing liquid to be sorted is put in a universally used hard tube of plastic, glass, or the like, and external force such as rotation or vibration is applied regularly from the device side to the tube or the suction nozzle itself, whereby cell sedimentation is suppressed. A DC motor, a stepping motor, an eccentric motor, or the like is used for a rotation or vibration mechanism, and since these motors generate heat during operation, it is necessary to devise a method that does not transfer heat to the cell suspension. Furthermore, anti-vibration design is extremely important that prevents noise from being brought to a flow rate sensor, a pressure sensor, and a laser optical system, and it has been a problem that the vibration removal design is a constraint of the device design.

### Solutions to Problems

Thus, the present inventors have conducted diligent research for solving the above-described problems, and have developed a microparticle-containing liquid dispersing device that can disperse microparticles such as cells and a microparticle sedimentation suppression method, a microparticle sorting or measuring device, and a microparticle sedimentation suppression vibrator.

That is, the present technology provides a microparticle-containing liquid dispersing device including a microparticle sedimentation suppression vibrator including a fixture configured to connect and hang on a bag having a flexibility and containing a microparticle-containing liquid, the microparticle sedimentation suppression vibrator hanging the bag in a vertically downward direction.

The bag is preferably molded by using an olefin-based plastic, a polyester-based elastomer, a polyurethane-based elastomer, a polyvinyl chloride-based elastomer, or a polyethylene-based elastomer as a material.

The bag can have an upper end, a lower end, and a lateral end that are demarcated,

the upper end can have an outflow port through which the microparticle-containing liquid flows out,

the outflow port can have a conduit that extends toward the lower end and through which the microparticle-containing liquid is fed, and

the lower end can have a bottom in which the microparticles are stored and that has a slope in part or all of the bottom.

The bag can include an attachment and detachment portion of the microparticle sedimentation suppression vibrator at the lateral end and/or the lower end.

Furthermore, an inner surface of the bag may be coated.

Moreover, the microparticle-containing liquid dispersing device preferably further includes a vibrator control unit.

Furthermore, the present technology provides a microparticle sedimentation suppression method including: hanging a microparticle sedimentation suppression vibrator on a bag containing the microparticle-containing liquid, the microparticle sedimentation suppression vibrator including a fixture configured to connect and hang on the bag containing the microparticle-containing liquid, the microparticle sedimentation suppression vibrator hanging the bag in a vertically downward direction; and swinging the bag by operating the microparticle sedimentation suppression vibrator.

Here, the bag can be hung on a stand, and the microparticle sedimentation suppression vibrator is preferably fixed to a vertical lower end farthest from a suspension fulcrum of the bag hung on the stand.

The microparticle sedimentation suppression vibrator can be controlled by a vibrator control unit that changes a drive waveform of the microparticle sedimentation suppression vibrator.

Furthermore, the drive waveform can be a waveform selected from the group consisting of a pulse waveform, a sine waveform, a sweep waveform, a triangle waveform, a sawtooth waveform, a square waveform, a trapezoidal waveform, and a stepped waveform and a multi-stage waveform thereof.

Furthermore, the present technology provides a microparticle sorting or measuring device including the microparticle-containing liquid dispersing device.

Moreover, the present technology provides a microparticle sedimentation suppression vibrator including a fixture configured to connect and hang on a bag containing a microparticle-containing liquid, and a vibrator.

Here, the vibrator is, for example, an electric actuator, and the fixture is enabled to connect and hang on the bag by fixing by adhesion, press fitting, insertion, screwing, magnetic force, a spring member, or the like.

Furthermore, the microparticles can be cells.

### Effects of the Invention

According to the present technology, the microparticles in the microparticle-containing liquid are dispersed, and the liquid is fed at a constant concentration during sorting. Note that, the effect described here is not necessarily limited, and can be any effect described in the present disclosure.

### BRIEF DESCRIPTION OF DRAWINGS

FIG. 1 is a diagram schematically illustrating a microparticle-containing liquid dispersing device.

FIG. 2 is a diagram illustrating a bag.

FIG. 3 is a diagram illustrating a bag.

FIG. 4 is a diagram illustrating an image in which a microparticle sedimentation suppression vibrator is attached to a bag to suppress particle sedimentation.

FIG. 5 is a diagram explaining a mechanism in which convection occurs in a liquid in a bag by the microparticle sedimentation suppression vibrator attached to the bag.

FIG. 6 is a diagram illustrating a bag posture control effect provided by the microparticle sedimentation suppression vibrator.

FIG. 7 is a photograph substituting a drawing illustrating an example of the microparticle sedimentation suppression vibrator.

FIG. 8 is a photograph substituting a drawing illustrating an example of the microparticle sedimentation suppression vibrator.

FIG. 9 is a photograph substituting a drawing illustrating an embodiment of the present technology.

FIG. 10 is a diagram illustrating vibrator drive waveforms by a vibrator control unit.

FIG. 11 is a diagram schematically illustrating an example of a microparticle sorting device.

FIG. 12 is a diagram illustrating a configuration of a microparticle sorting kit.

### MODE FOR CARRYING OUT THE INVENTION

Hereinafter, a description will be given of preferred embodiments for carrying out the present technology. Note that, the embodiments described below are representative embodiments of the present technology, and the scope of the present technology should not be construed narrowly. The description will be made in the following order.

1. Microparticle-containing liquid dispersing device
1-1. Overall configuration
1-2. Bag

2. Microparticle sedimentation suppression method
2-1. Mechanism of microparticle sedimentation suppression
2-2. Microparticle sedimentation suppression vibrator
2-3. Vibrator control unit

3. Microparticle sorting or measuring device

<1. Microparticle-Containing Liquid Dispersing Device>

1-1. Overall Configuration

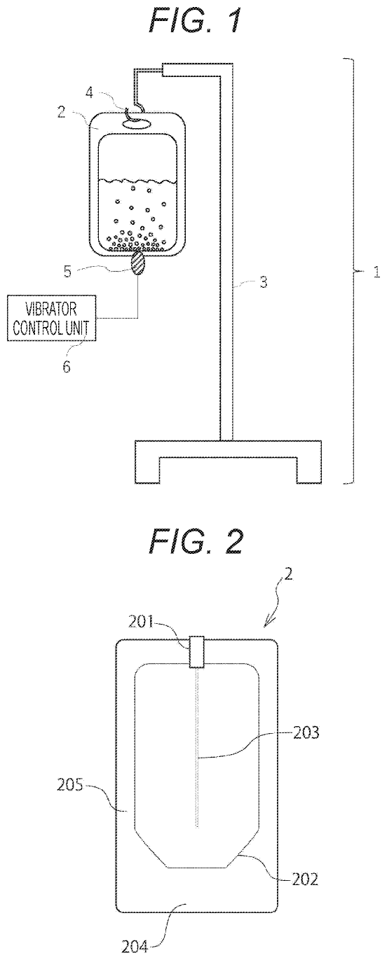

A description will be given with reference to FIG. 1.

A microparticle-containing liquid dispersing device 1 includes at least a bag 2, a stand 3 (including a hook 4), a microparticle dispersion vibrator 5, and a vibrator control unit 6.

The bag 2 contains a microparticle-containing liquid. Microparticles can be ones to be sorted, measured, or analyzed. In the present technology, the microparticles broadly include cells, microorganisms, and bio-related microparticles such as liposomes, or synthetic particles such as latex particles, gel particles, and industrial particles.

The bio-related microparticles include chromosomes, liposomes, mitochondria, organelles (cell organelles), and the like that make up various cells. The cells include animal cells (such as hematopoietic cells) and plant cells. The microorganisms include bacteria such as Escherichia coli, viruses such as tobacco mosaic virus, fungi such as yeast, and the like. Moreover, the bio-related microparticles can include bio-related macromolecules such as nucleic acids, proteins, and complexes thereof. Furthermore, the industrial particles may be, for example, an organic or inorganic polymer material, a metal, or the like. The organic polymer material includes polystyrene, styrene/divinylbenzene, polymethylmethacrylate, and the like. The inorganic polymer material includes glass, silica, magnetic material, and the like. The metal includes gold colloid, aluminum, and the like. The shape of these microparticles is generally spherical, but may be non-spherical, and the size and mass are not particularly limited.

The stand 3 includes the hook 4, and for example, the bag 2 is hung on the hook 4 through a hole formed in the upper part of the bag 2. The hook 4 is not limited to a hook as long as the bag 2 can be hung, and is only required to have a structure of, for example, a clip or the like.

On the lower part of the bag 2, the microparticle sedimentation suppression vibrator 5 is attached. The microparticle sedimentation suppression vibrator swings to suppress sedimentation of the microparticles in the bag. The vibration time, the vibration pattern, and the like are controlled by the vibrator control unit 6. The microparticle sedimentation suppression vibrator 5 and the vibrator control unit 6 will be described later.

1-2. Bag

FIG. 2 is a schematic diagram illustrating one form of the bag 2 used in the present technology.

It is preferable that the upper end of the bag 2 has an outflow port 201 through which the microparticle-containing liquid flows out. The outflow port 201 has a conduit 203 through which the microparticle-containing liquid is fed. The conduit 203 extends from the outflow port 201 towards the lower end of the bag. Although the length of the conduit 203 is not particularly limited, the lower end of the conduit is preferably close to the lower end of the bag so that most of the microparticle-containing liquid can flow out; however, the conduit 203 may be formed to be able to change the length depending on the amount of residual liquid in the bag 2.

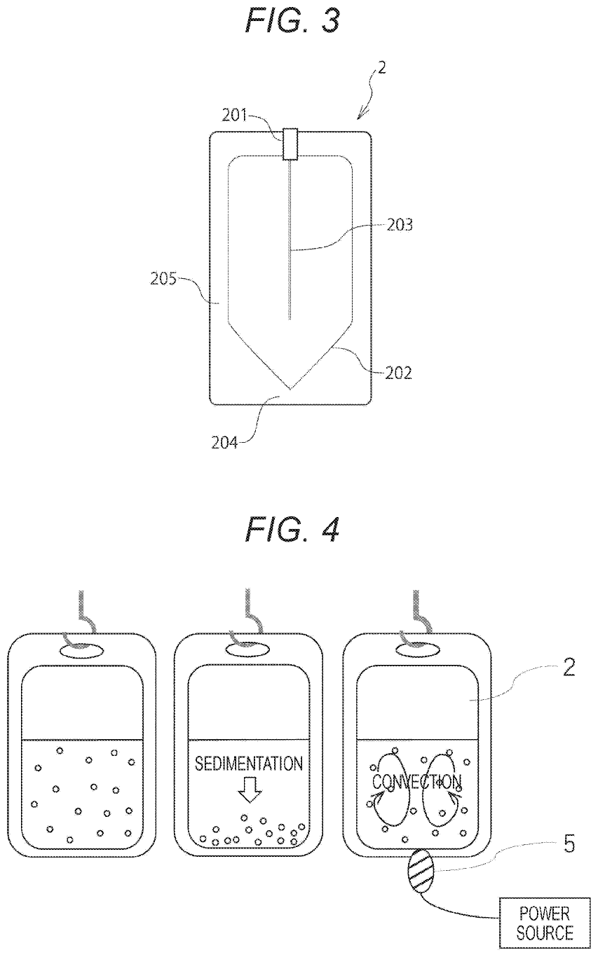

The lower end of the bag preferably has a bottom having a slope in part or all thereof so that the microparticles are preferably stored. FIG. 2 illustrates an example in which a slope 202 exists in a part of the lower end, and FIG. 3 illustrates an example in which the slope 202 exists in all of the lower end. The shape of the lower end is not limited to these.

A lower end 204 and/or a lateral end 205 of the bag is only required to have a width in which the microparticle sedimentation suppression vibrator 5 can be attached and detached.

The upper end of the bag has the outflow port 201. The microparticle-containing liquid sucked from the conduit 203 flows through the outflow port 201 to an outer tube coupled to the outflow port 201.

The material of the outflow port is not particularly limited, and examples thereof include rubber materials such as butyl rubber, isoprene rubber, and natural rubber, high molecular elastomers such as a styrene-based elastomer, an olefin-based elastomer, a polyester-based elastomer, and a nylon-based elastomer, and thermoplastic resins such as low-density polyethylene, high-density polyethylene, polypropylene, and cyclic polyolefin, and the like.

Furthermore, it is preferable that the upper end of the bag and the space between the upper end and the outflow port 201 are sealed so that contamination or the like does not occur.

The material of the bag 2 is not particularly limited, but is preferably olefin-based plastic. Specifically, the material may be polyethylene, polypropylene, polyamide (nylon), or a cyclic polyolefin such as a cycloolefin polymer or a cycloolefin copolymer. Furthermore, the material may be an olefin-based elastomer in which polyethylene, polypropylene, or the like is used as a hard segment and polybutadiene rubber or the like is used as a soft segment. For example, the material is a polyethylene-based elastomer. Alternatively, the material may be a thermoplastic elastomer such as a polyester-based elastomer, a polyurethane-based elastomer or a polyvinyl chloride-based elastomer.

In the bag 2, the upper end, the lower end, and the lateral end are demarcated as illustrated in FIG. 2. If the above-described material of the bag 2 is used, the ends can be easily demarcated by sealing or the like. The lower end and the lateral end can be used as an attachment and detachment portion of the microparticle sedimentation suppression vibrator.

Furthermore, to reduce nonspecific adsorption of microparticles, a coating is preferably applied to at least the inner surface of the bag 2. The coating agent is not particularly limited, but is preferably an agent based on one selected from the group consisting of low molecular weight protein, silicon, and water soluble polymer. Furthermore, the low molecular weight protein is preferably albumin, the water soluble polymer is at least one or more selected from the group consisting of casein, gelatin, dextran, polyacrylamide, polyvinyl alcohol, polyvinyl prolidone, and polyethylene glycol.

In addition, a port, a tube, and the like can be installed in the bag 2 as necessary.

For details of the bag 2, refer to Japanese Patent Application No. 2017-043714.

<2. Microparticle Sedimentation Suppression Method>

The microparticle sedimentation suppression method of the present technology is a method including: hanging a microparticle sedimentation suppression vibrator on a bag containing the microparticle-containing liquid, the microparticle sedimentation suppression vibrator including a fixture configured to connect and hang on the bag containing the microparticle-containing liquid, the microparticle sedimentation suppression vibrator hanging the bag in a vertically downward direction; and swinging the bag by operating the microparticle sedimentation suppression vibrator.

2-1. Mechanism of Microparticle Sedimentation Suppression

As illustrated on the left side of FIG. 4, the bag 2 is hung on the hook 4 of the stand 3. As illustrated in the center of FIG. 4, if the bag is left standing, the microparticles sediments. Thus, as illustrated on the right side of FIG. 4, the microparticle sedimentation suppression vibrator 5 is attached to the bag 2 to apply vibration.

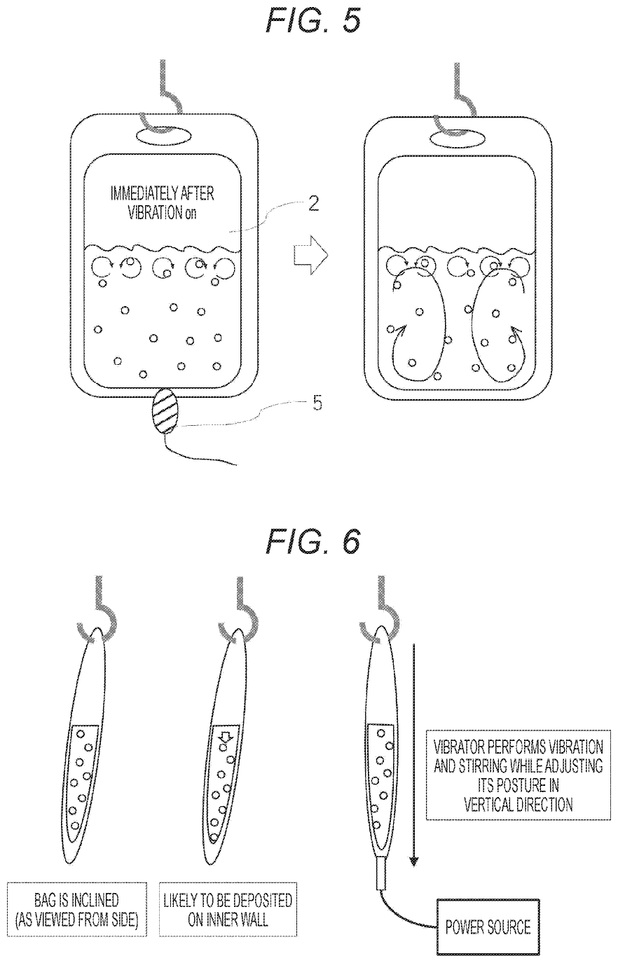

Immediately after the microparticle sedimentation suppression vibrator 5 is driven, as illustrated in FIG. 5, strong convection occurs near the liquid surface since the liquid surface is the vibration open end, but eventually the convection near the surface grows, and a large convection is formed that involves the whole. The convection velocity is greater than the sedimentation speed of the microparticles, whereby the microparticles do not sediment and the concentration is kept uniform while the microparticle sedimentation suppression vibrator 5 is driven. Furthermore, even if there are bubbles trapped, or water droplets splashed or condensed on the inner wall of the bag 2, those can be eliminated by applying vibration.

Furthermore, when the bag 2 is swung by the microparticle sedimentation suppression vibrator 5, shearing force is generated between the inner wall of the bag and the particle dispersion liquid, and a complicated flow field is formed by the inertial resistance and the viscous resistance, whereby sedimentation is suppressed.

Moreover, it is characterized in that since the water surface of the particle dispersion liquid in the bag serves as an open end of vibration transmission, the degree of freedom of vibration of the water surface is high, that is, strong convection is likely to be formed, and a large swirling flow in the entire bag is formed with this convection as a trigger.

Furthermore, as illustrated in the left side of FIG. 6, when the bag 2 is hung on the hook 4, the bag 2 may be inclined when viewed from the side of the bag 2.

In general, the bag includes a flexible film, and waviness due to wrinkles or a peculiarity of the bag may often remain even after the liquid is put in, and the hanging posture may often be inclined without being held in the vertical direction in a case where the liquid amount is small. In such a case, as illustrated in the center of FIG. 6, the particles tend to sediment and be deposited on the inner wall surface.

Thus, as illustrated on the right side of FIG. 6, the microparticle sedimentation suppression vibrator 5 is fixed to a position as far as possible from the hook 4, for example, to a vertical lower end. As a result, then, with the weight of the microparticle sedimentation suppression vibrator 5, force is effectively exerted to correct the posture of the bag 2 in the vertical direction due to a moment, and vibration can be applied in a state in which the particles are unlikely to be deposited on the inner wall. That is, the microparticle sedimentation suppression vibrator 5 also functions as a weight. Furthermore, it is possible to apply vibration while extremely suppressing reaction force to the microparticle-containing liquid dispersing device, or a microparticle sorting or measuring device described later, and design constraints for vibration removal and heat generation is relaxed.

Note that, the weight of the weight is not particularly limited, but is preferably greater than or equal to 1 g.

Connecting and hanging the microparticle sedimentation suppression vibrator 5 on the bag 2 may be performed by direct fixing to the bag 2 by using an adhesive, a tape, or the like, or by fixing by using press fitting, insertion, screwing, magnetic force, spring member, or the like.

Furthermore, the length of a cord connecting the microparticle sedimentation suppression vibrator 5 to a power source is appropriately adjusted so that the bag 2 does not lose its posture. Alternatively, the microparticle sedimentation suppression vibrator 5 may have a configuration including a built in battery to eliminate the power cord.

2-2. Microparticle Sedimentation Suppression Vibrator

An electric actuator is typically mentioned as the microparticle sedimentation suppression vibrator 5, and for example, current/piezo driven elements can be used such as a piezoelectric element, a linear vibration actuator, a cylindrical eccentric AC/DC motor, a coin type eccentric AC/DC motor, and the like. For example, in the case of the coin type eccentric motor, when the rotational speed is set to about 5000 to 20000 rpm, sedimentation can be suppressed in a case where the microparticles are cells, for example.

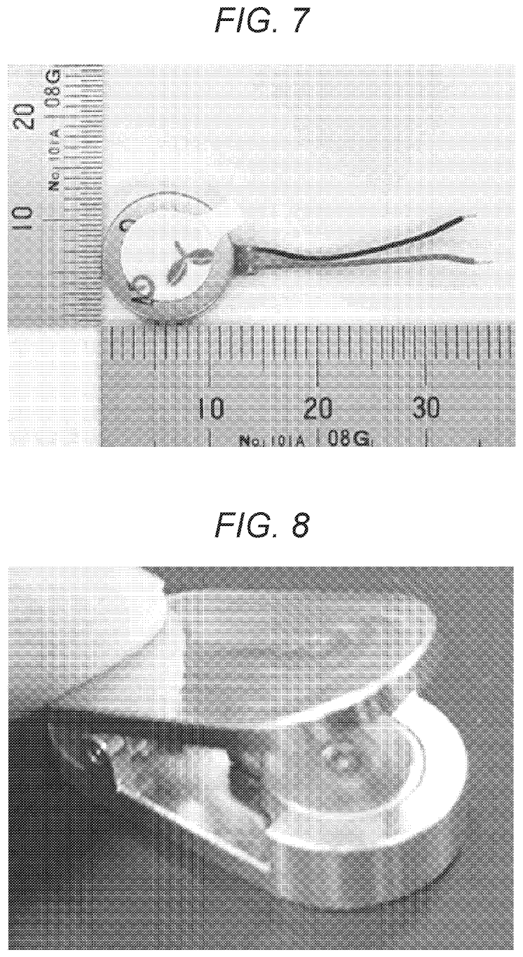

As an example of the microparticle sedimentation suppression vibrator, a microparticle sedimentation suppression vibrator is illustrated (FIG. 8) in which a commercially available coin type eccentric motor (FIG. 7) is combined with a torsion spring and made into a clip type one.

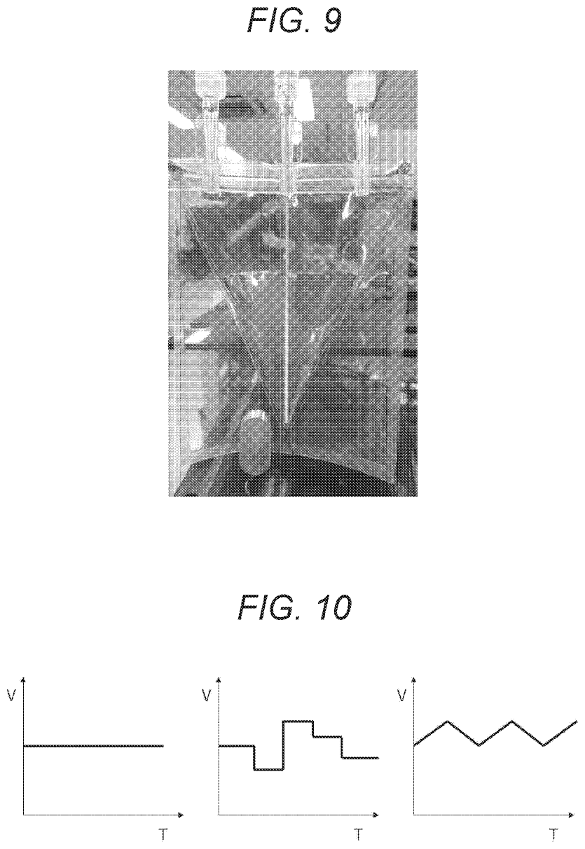

The microparticle sedimentation suppression vibrator is used by being hung in the vertically downward direction of the bag (FIG. 9).

As described above, the microparticle sedimentation suppression vibrator can be easily replaced by a user regardless of whether power supply from the power source is wired or battery-powered, so that the microparticle sedimentation suppression vibrator also has high maintainability.

2-3. Vibrator Control Unit

In driving the microparticle sedimentation suppression vibrator 5, a method is also included in which a vibration mode is changed by making the drive waveform of the current/voltage of the element in a pulse shape, a sweep shape, a step shape, a multi-stage shape (FIG. 10), or the like, to cause convection for suppressing sedimentation to be more complicated and made faster.

Since the vibration mode in the liquid is further changed by changing the voltage in multiple stages within the drive voltage range or sweeping the voltage than by driving the vibrator at a constant voltage, the convection formed becomes a more complicated flow and stirring force of the microparticles is increased.

The drive waveform is a wave form selected from the group consisting of, for example, a pulse waveform, a sine waveform, a sweep waveform, a triangle waveform, a sawtooth waveform, a square waveform, a trapezoidal waveform, and a stepped waveform and multi-stage waveform thereof; however, the waveform is not limited to these, and the combination is also not limited.

The vibrator control unit can manually or automatically select the waveform depending on a dispersion state in the microparticle-containing liquid. The dispersion state of the microparticles may be visually detected, may be detected by using an imaging device or the liked, or may be detected by labeling the microparticles with phosphor or the like.

The vibration time may be a time until sorting of the microparticles is completed or until the microparticle-containing liquid in the bag 2 is exhausted; however, the vibration time may be appropriately delimited depending on the dispersion state of the microparticles.

These motions of the vibrator are only required to be executed by a predetermined program incorporated in or coupled to the vibrator control unit.

<3. Microparticle Sorting or Measuring Device>

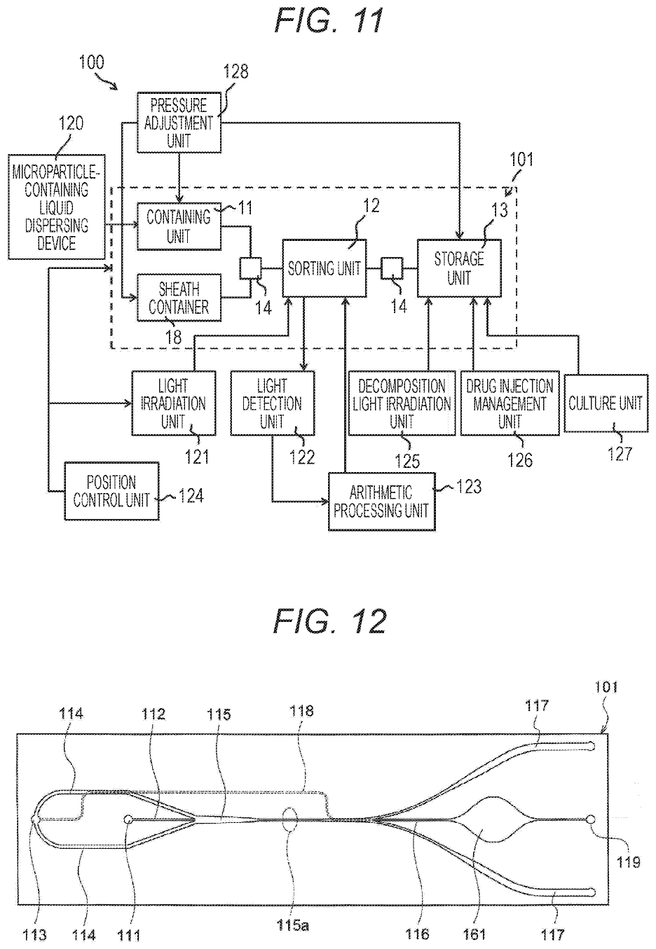

FIG. 11 illustrates an example of an embodiment of a microparticle sorting device 100 according to the present technology.

As illustrated in FIG. 11, the microparticle sorting device 100 includes a microparticle-containing liquid dispersing device 120, a sorting unit 12, a light irradiation unit 121, a light detection unit 122, and an arithmetic processing unit 123, and may include a position control unit 124, a decomposition light irradiation unit 125, a drug injection management unit 126, a culture unit 127, a pressure adjustment unit 128, and the like, as necessary. Hereinafter, each unit will be described.

(1) Microparticle-Containing Liquid Dispersing Device

The microparticle-containing liquid dispersing device is as illustrated in FIG. 1, and the description is omitted.

(2) Sorting Unit

The microparticle sorting device 100 according to the present technology includes a microparticle sorting kit 101 that sorts and stores microparticles as the sorting unit 12.

A configuration of the microparticle sorting kit 101 is illustrated in FIG. 12.

The microparticle-containing liquid sent from the microparticle-containing liquid dispersing device 120 is introduced into a microparticle-containing liquid flow channel 112 from a microparticle-containing liquid inlet 111. Furthermore, a sheath liquid is introduced from a sheath liquid inlet 113. The sheath liquid introduced from the sheath liquid inlet 113 is divided into two sheath liquid flow channels 114, 114 and fed. The microparticle-containing liquid flow channel 112 and the sheath liquid flow channels 114, 114 merge together to form a main flow channel 115. A microparticle-containing liquid laminar flow S fed through the microparticle-containing liquid flow channel 112 and a sheath liquid laminar flow T fed through the sheath liquid flow channels 114, 114 merge together in the main flow channel 115, to form a sheath flow in which the particle-containing liquid laminar flow is sandwiched between the sheath liquid laminar flows.

Furthermore, the sheath liquid introduced from the sheath liquid inlet 113 is also fed to a sheath liquid bypass flow channel 118 formed separately from the sheath liquid flow channel 114. One end of the sheath liquid bypass flow channel 118 is connected to the sheath liquid inlet 113, and the other end is connected to the vicinity of a communication port of a sorting flow channel 116 described later to the main flow channel 115. A sheath liquid introduction end of the sheath liquid bypass flow channel 118 is only required to be connected to any portion of a sheath liquid flow area including the sheath liquid inlet 113 and the sheath liquid flow channels 114, 114, but is preferably connected to the sheath liquid inlet 113. By connecting the sheath liquid bypass flow channel 118 to the center position that makes the two sheath liquid flow channels 114 geometrically symmetrical with each other (that is, the sheath liquid inlet 113), the sheath liquid can be distributed to the two sheath liquid flow channels 114 at an equal flow rate.

A reference numeral 115a in FIG. 12 indicates a detection region that is irradiated with excitation light and in which fluorescence and scattered light emitted from the microparticles are detected. The microparticle-containing liquid is fed to the detection region 115a in a state of being arranged in a line in the sheath flow formed in the main flow channel 115, and is irradiated with the excitation light.

The main flow channel 115 branches into three flow channels at the downstream side of the detection region 115a. The main flow channel 115 communicates with three branch flow channels, the sorting flow channel 116 and discard flow channels 117, 117, at the downstream side of the detection region 115a. Among these, the sorting flow channel 116 is a flow channel through which the microparticle-containing liquid is taken in. The microparticles other than target microparticles contained in the microparticle-containing liquid flow into either one of the two discard flow channels 117 without being taken into the sorting flow channel 116.

Taking the microparticle-containing liquid into the sorting flow channel 116 is performed by generating a negative pressure in the sorting flow channel 116, and sucking the target microparticles into the sorting flow channel 116 by using the negative pressure. For the negative pressure, a piezoelectric element such as a piezo element is arranged at a position corresponding to a pressure chamber 161 provided as a region in which the inner space is expanded in the sorting flow channel 116.

(3) Light Irradiation Unit

The microparticle sorting device 100 according to the present technology includes the light irradiation unit 121 that irradiates the microparticle sample with light.

Specifically, the light irradiation unit 121 irradiates the microparticles flowing through the detection region 115a provided on the main flow channel 115 with light (excitation light).

The light irradiation unit 121 includes, for example, a light source that emits excitation light, an objective lens that focuses the excitation light on the microparticles flowing through the main flow channel 115, and the like. The light source is appropriately selected from a laser diode, an SHG laser, a solid-state laser, a gas laser, a high-brightness LED, and the like depending on the purpose of analysis. The light irradiation unit 121 may include an optical element other than the light source and the objective lens, as necessary.

(4) Light Detection Unit

The microparticle sorting device 101 according to the present technology includes the light detection unit 122 that detects fluorescence and scattered light emitted from the microparticle sample irradiated with excitation light.

Specifically, the light detection unit 122 detects fluorescence and scattered light emitted from the microparticle sample and converts them into an electric signal. Then, the electric signal is output to the arithmetic processing unit 123.

The configuration of the light detection unit 122 is not particularly limited, a known configuration can be adopted, and the method of conversion into an electric signal is also not particularly limited.

(5) Arithmetic Processing Unit

The microparticle sorting device 100 according to the present technology includes the arithmetic processing unit 123 to which the electric signal converted by the light detection unit 122 is input.

The arithmetic processing unit 123 determines optical characteristics of the microparticle-containing liquid and the microparticles contained in the microparticle-containing liquid on the basis of the input electric signal.

Moreover, the arithmetic processing unit 123 includes a gating circuit that calculates a threshold value for sorting the microparticles from the microparticle-containing liquid, a threshold value for determining whether or not the required number of microparticles or more have been sorted, a threshold value for selecting microparticles on the basis of the fluorescence intensity by fluorescent dye for labeling, and the like.

With the configuration of this gating circuit, in a case where the threshold value for sorting the microparticles from the microparticle sample is calculated, this is converted into an electric signal for sorting, and the pressure of the pressure chamber 161 is output.

Note that, the configuration of the arithmetic processing unit 123 is not particularly limited, and a known configuration can be adopted. Moreover, as the arithmetic processing method performed by the gating circuit of the arithmetic processing unit 123, a known method can be adopted.

(6) Position Control Unit

The microparticle sorting device 100 according to the present technology may include the position control unit 124, as necessary.

The excitation light needs to irradiate the detection region 115a of the microparticle sorting kit 101, and the position control unit 124 controls a relative positional relationship between the microparticle sorting kit 101 and the light irradiation unit 121.

The configuration of the position control unit 124 is not particularly limited, a known configuration can be adopted, and examples thereof include an actuator serving as a drive source.

(7) Decomposition Light Irradiation Unit

The microparticle sorting device 100 according to the present technology may include the decomposition light irradiation unit 125, as necessary.

In a case where the microparticle sorting kit 101 includes, for example, a labeling unit and the microparticles are labeled with a fluorescent dye through a photodegradable linker, it is necessary to exclude the fluorescent dye from the microparticle-containing liquid depending on the use environment.

The decomposition light irradiation unit 125 irradiates the photodegradable linker with predetermined light. As a result, the fluorescent dye can be excluded from the microparticle sample.

Here, the wavelength of the light with which the degradable linker is irradiated is only required to be a wavelength corresponding to each photodegradable linker. For example, in the case of methoxynitrobenzyl, the decomposition efficiency is best at 346 nm, and when this decomposition efficiency is set as 1, the decomposition efficiency is 0.89 at 364 nm, 0.15 at 406 nm, and 0.007 at 487 nm. A wavelength of less than or equal to 300 nm may damage the microparticle sample and is preferably not used. Furthermore, it is preferable to perform irradiation at, for example, 30 mW/cm\hat{ }2, 100 sec.→3 J/cm\hat{ }2, or the like in which the microparticle sample, in particular, the microparticles are not damaged. As the amount of irradiation, in a case where the microparticles are cells, although it depends on the species, it is said that 500 J/cm\hat{ }2 damages DNA and inhibits cell growth (Callegari, A. J. & Kelly, T. J. Shedding light on the DNA damage check point. Cell Cycle 6, 660-6 (2007)). Furthermore, there is also a report that 42 J/cm\hat{ }2 does not cause cytotoxicity (Masato T, et al, Optical cell separation from three-dimensional environment in photodegradable hydrogels for pure culture techniques, Scientific Reports 4, Article number. 4793 (2014)).

(8) Drug Injection Management Unit

The microparticle sorting device 100 according to the present technology may include the drug injection management unit 126, as necessary.

The microparticles stored in a storage unit 13 of the microparticle sorting kit 101 need to be subjected to activation and gene introduction, as necessary, and the drug injection management unit 126 injects into the storage unit 13 a drug for activating the microparticles and a drug for introducing a gene into the microparticles. Alternatively, the amount of injection of each drug, or the like is managed depending on the state of the stored microparticles.

As the drugs, known drugs can be used such as various cytokines (interleukin-2 (IL-2), IL-7, IL-15, IL-21, and the like) and various antibodies (anti-CD3 antibody, anti-CD28 antibody, and the like), for activation, and viral vectors (adeno-associated virus vector, adenovirus vector, retrovirus vector, lentivirus vector, and the like) into which a plasmid that expresses a target gene is introduced, for gene introduction, and an appropriate one can be selected depending on the type and state of the stored microparticles. Moreover, a plurality of types of known drugs can be used in combination.

(9) Culture Unit

The microparticle sorting device 100 according to the present technology may include the culture unit 127, as necessary.

It is considered necessary to increase the number of microparticles sorted by the microparticle sorting kit 101 depending on the application of the microparticle sorting device 100. That is, the culture unit 127 cultures the microparticles (for example, single cells) stored in the storage unit 13.

Specifically, temperature control inside the storage unit is performed to increase the microparticles contained in the storage unit.

Note that, the temperature adjustment method in the culture unit 127 is not particularly limited, a known method can be adopted, and, for example, a heating element may be provided in the storage unit, and an electric signal for controlling a temperature rise/fall may be output to the heating element from the culture unit 127.

(10) Pressure Adjustment Unit

The microparticle sorting device 100 according to the present technology may include the pressure adjustment unit 128, as necessary.

As described above, in the microparticle sorting kit 101, the containing unit 11, the sorting unit 12, and the storage unit 13 are hermetically connected to each other (sealing portion 14), so that a pressure change in the storage unit 13 may cause pressure changes in the containing unit 11 and/or the sorting unit 12. The pressure adjustment unit 128 adjusts the pressure inside the storage unit 13.

Specifically, the pressure adjustment unit 128 is configured to generate a negative pressure inside the storage unit 13, and examples thereof include a piezoelectric element such as a piezo element.

Moreover, it is preferable that the pressure adjustment unit 128 is configured to adjust the pressure inside the containing unit 11 by adjusting the flow rate of the microparticle sample flowing out from the containing unit 11. In addition, it is preferable that the pressure adjustment unit 128 is configured to adjust the pressure inside a sheath container 18 by adjusting the flow rate of the sheath liquid flowing out from the sheath container 18.

(11) Other Configurations

The microparticle sorting device 100 according to the present technology may include a separation unit (not illustrated) that performs separation described above. The separation unit may be, for example, a known centrifugal separator, and configured to centrifuge the microparticles in the entire microparticle sorting kit 101 or a microparticle containing unit (not illustrated) included in the microparticle sorting kit 101.

Note that, the present technology can also be configured as described below.

[1] A microparticle-containing liquid dispersing device including a microparticle sedimentation suppression vibrator including a fixture configured to connect and hang on a bag having a flexibility and containing a microparticle-containing liquid, the microparticle sedimentation suppression vibrator hanging the bag in a vertically downward direction.
[2] The microparticle-containing liquid dispersing device according to [1], in which the bag is molded by using an olefin-based plastic, a polyester-based elastomer, a polyurethane-based elastomer, a polyvinyl chloride-based elastomer, or a polyethylene-based elastomer as a material.
[3] The microparticle-containing liquid dispersing device according to [1] or [2], in which

the bag has an upper end, a lower end, and a lateral end that are demarcated,

the upper end has an outflow port through which the microparticle-containing liquid flows out,

the outflow port has a conduit that extends toward the lower end and through which the microparticle-containing liquid is fed, and

the lower end has a bottom in which the microparticles are stored and that has a slope in part or all of the bottom.

[4] The microparticle-containing liquid dispersing device according to any of [1] to [3], in which the bag includes an attachment and detachment portion of the microparticle sedimentation suppression vibrator at the lateral end and/or the lower end.
[5] The microparticle-containing liquid dispersing device according to any of [1] to [4], in which an inner surface of the bag is coated. [6] The microparticle-containing liquid dispersing device according to any of [1] to [5], further including a vibrator control unit. [7] A microparticle sedimentation suppression method including: hanging a microparticle sedimentation suppression vibrator on a bag containing the microparticle-containing liquid, the microparticle sedimentation suppression vibrator including a fixture configured to connect and hang on the bag containing the microparticle-containing liquid, the microparticle sedimentation suppression vibrator hanging the bag in a vertically downward direction; and swinging the bag by operating the microparticle sedimentation suppression vibrator.
[8] The microparticle sedimentation suppression method according to [7], in which the bag is hung on a stand.
[9] The microparticle sedimentation suppression method according to [7] or [8], in which the microparticle sedimentation suppression vibrator is fixed to a vertical lower end farthest from a suspension fulcrum of the bag hung on the stand.
[10] The microparticle sedimentation suppression method according to any of [7] to [9], in which the microparticle sedimentation suppression vibrator is controlled by a vibrator control unit that changes a drive waveform of the microparticle sedimentation suppression vibrator.
[11] The microparticle sedimentation suppression method according to [10], in which the drive waveform is a waveform selected from the group consisting of a pulse waveform, a sine waveform, a sweep waveform, a triangle waveform, a sawtooth waveform, a square waveform, a trapezoidal waveform, and a stepped waveform and a multi-stage waveform thereof.
[12] A microparticle sorting or measuring device including the microparticle-containing liquid dispersing device according to any of [1] to [6].
[13] A microparticle sedimentation suppression vibrator including a fixture configured to connect and hang on a bag containing a microparticle-containing liquid, and a vibrator.
[14] The microparticle sedimentation suppression vibrator according to [13], in which the vibrator is an electric actuator.
[15] The microparticle sedimentation suppression vibrator according to [13] or [14], in which the fixture is enabled to connect and hang on the bag by fixing by adhesion, press fitting, insertion, screwing, magnetic force, or a spring member.
[16] The microparticle sedimentation suppression vibrator according to any of [13] to [15], in which the microparticles are cells.

### REFERENCE SIGNS LIST

1, 120 Microparticle-containing liquid dispersing device
2 Bag
3 Stand
4 Hook
5 Microparticle dispersion vibrator
6 Vibrator control unit
100 Microparticle sorting device
101 Microparticle sorting kit
201 Outflow port
202 Slope
203 Conduit

1. A microparticle-containing liquid dispersing device comprising a microparticle sedimentation suppression vibrator including a fixture configured to connect and hang on a bag having a flexibility and containing a microparticle-containing liquid, the microparticle sedimentation suppression vibrator hanging the bag in a vertically downward direction.

2. The microparticle-containing liquid dispersing device according to claim 1, wherein the bag is molded by using an olefin-based plastic, a polyester-based elastomer, a polyurethane-based elastomer, a polyvinyl chloride-based elastomer, or a polyethylene-based elastomer as a material.

3. The microparticle-containing liquid dispersing device according to claim 1, wherein
the bag has an upper end, a lower end, and a lateral end that are demarcated,
the upper end has an outflow port through which the microparticle-containing liquid flows out,
the outflow port has a conduit that extends toward the lower end and through which the microparticle-containing liquid is fed, and
the lower end has a bottom in which the microparticles are stored and that has a slope in part or all of the bottom.

4. The microparticle-containing liquid dispersing device according to claim 1, wherein the bag includes an attachment and detachment portion of the microparticle sedimentation suppression vibrator at the lateral end and/or the lower end.

5. The microparticle-containing liquid dispersing device according to claim 1, wherein an inner surface of the bag is coated.

6. The microparticle-containing liquid dispersing device according to claim 1, further comprising a vibrator control unit.

7. A microparticle sedimentation suppression method comprising: hanging a microparticle sedimentation suppression vibrator on a bag containing the microparticle-containing liquid, the microparticle sedimentation suppression vibrator including a fixture configured to connect and hang on the bag containing the microparticle-containing liquid, the microparticle sedimentation suppression vibrator hanging the bag in a vertically downward direction; and swinging the bag by operating the microparticle sedimentation suppression vibrator.

8. The microparticle sedimentation suppression method according to claim 7, wherein the bag is hung on a stand.

9. The microparticle sedimentation suppression method according to claim 7, wherein the microparticle sedimentation suppression vibrator is fixed to a vertical lower end farthest from a suspension fulcrum of the bag hung on the stand.

10. The microparticle sedimentation suppression method according to claim 7, wherein the microparticle sedimentation suppression vibrator is controlled by a vibrator control unit that changes a drive waveform of the microparticle sedimentation suppression vibrator.

11. The microparticle sedimentation suppression method according to claim 10, wherein the drive waveform is a waveform selected from a group consisting of a pulse waveform, a sine waveform, a sweep waveform, a triangle waveform, a sawtooth waveform, a square waveform, a trapezoidal waveform, and a stepped waveform and a multi-stage waveform thereof.

12. A microparticle sorting or measuring device comprising the microparticle-containing liquid dispersing device according to claim 1.

13. A microparticle sedimentation suppression vibrator comprising a fixture configured to connect and hang on a bag containing a microparticle-containing liquid, and a vibrator.

14. The microparticle sedimentation suppression vibrator according to claim 13, wherein the vibrator is an electric actuator.

15. The microparticle sedimentation suppression vibrator according to claim 13, wherein the fixture is enabled to connect and hang on the bag by fixing by adhesion, press fitting, insertion, screwing, magnetic force, or a spring member.

16. The microparticle sedimentation suppression vibrator according to claim 13, wherein the microparticles are cells.
